(19) United States
(12) Patent Application Publication
(10) Pub. No.: US 2026/0194785 A1
(43) Pub. Date: Jul. 9, 2026

(54) METHOD AND APPARATUS FOR THE GENERATION OF SECOND HARMONIC RADIATION BY MEANS OF CRYSTALS WITH NONCRITICAL PHASE MATCHING, WITH CONTROL OVER THE RELATIVE PHASE BETWEEN A FUNDAMENTAL ELECTROMAGNETIC FIELD AND AN ELECTROMAGNETIC FIELD WITH DOUBLE FREQUENCY

(71) Applicant: LEOS S.r.L., Rovereto (Trento) (IT)

(72) Inventors: Barbara Michot, Rovereto (IT); Simone Serafini, Rovereto (IT); Nicola Gatti, Rovereto (IT); Louise Wolswijk, Rovereto (IT)

(21) Appl. No.: 19/132,267

(22) PCT Filed: Nov. 22, 2023
(86) PCT No.: PCT/IB2023/061774

§ 371 Date: May 22, 2025

(30) Foreign Application Priority Data
Nov. 24, 2022 (IT) 102022000024258

(51) Int. Cl. G02F 1/35; G02F 1/355; G02F 1/37

(52) U.S. Cl. CPC G02F 1/3503; G02F 1/3551; G02F 1/37

(57) ABSTRACT

A process for the generation of a second harmonic radiation from a fundamental radiation, comprising the following operating steps: providing one or more nonlinear crystals (C) that satisfy the condition of second harmonic generation (SHG) through noncritical phase matching; providing an optical phase actuator (A), positioned upstream or downstream of said nonlinear crystal (C) with respect to the main optical axis (O) of the nonlinear crystal, a step of varying one or more of said parameters of the optical actuator (A) over time by controlling the temperature of the optical actuator (A) itself, or by applying electric or magnetic fields to said optical actuator (A), determining said parameters of the optical actuator (A) for which said measured power is maximum with respect to the power measured during said plurality of measurements performed.

### TECHNICAL FIELD OF THE PRESENT INVENTION

The invention relates to a device for the generation of second harmonic radiation. In particular, it regards generating, from an electromagnetic field E_{ω}, with an angular frequency ω, a field E_{2ω} with an angular frequency 2ω, by passing light through one or more birefringent nonlinear crystals, under noncritical phase-matching conditions, i.e., the condition for which phase matching in the propagation of the fields E_{ω}, and E_{2ω} in the nonlinear crystal takes place by propagating fields along the same direction, making the variation in the index of refraction due to birefringence coincide with the variation in the index of refraction due to chromatic dispersion. In order to maintain such phase-matching conditions also in the case of propagation through multiple crystals or multiple passages through a same crystal, with the aim of maximising the final power of the second harmonic radiation, we present an actuator that allows for varying the relative phase Δφ_{E}_{_{ω}}_{, E}_{_{2ω}}=φ_{E}_{_{ω}}−φ_{E}_{_{2ω}} between the two fields at the input of the SHG (second harmonic generation) frequency doubling stages following the first in a controlled manner by acting on the temperature of a further birefringent crystal.

Solutions are also proposed for increasing the nonlinear conversion efficiency based on the composition, in sequence, of a number of crystals, combined with actuators for the control of the relative phase, and solutions for the transverse confinement of laser beams within the nonlinear crystals.

### STATE OF THE ART

For the purpose of obtaining electromagnetic radiation E_{2ω} with a frequency double that of a given electromagnetic field E_{ω} with an angular frequency ω, a common solution is to exploit second harmonic generation (SHG) processes, based on the propagation of the field E_{ω} through a nonlinear medium having a quadratic coefficient of electric susceptibility other than zero: χ₂≠0.

The size of the second harmonic field E_{2ω} is proportional to the length L of the nonlinear crystal passed through, provided that given conditions between the phases of the fundamental field E_{ω} and of the second harmonic field E_{2ω} are satisfied. Only under such conditions, referred to as phase matching, will the contributions to the field E_{2ω} from the various positions along the direction of propagation interfere constructively, thereby maximising the size of the second harmonic field at the output of the crystal.

Such phase-matching conditions correspond to requiring that the following relation apply between the wave vectors

$$\vec{k} = \frac{2 π}{λ} n \hat{k}$$

of the two fields E_{ω} and E_{2ω}:

$$\hat{k} * {\vec{k}}_{2 ω} = 2 {k}_{ω} , \qquad ( eq . 1 )$$

\hat{k} being the versor of the wave vector, * the scalar product operator between vectors, λ=2πc/ω the wavelength, and n the index of refraction of the medium.

For collinear wave vectors, \hat{k}_{ω}=\hat{k}_{2ω}, the phase-matching condition of eq. 1 is reduced to:

$${k}_{2 ω} = 2 {k}_{ω} .$$

This corresponds to the following condition for the indices of refraction:

$${n}_{2 ω} = {n}_{ω} .$$

For the purpose of satisfying the phase-matching condition, a frequent approach is based on the use of birefringent nonlinear crystals. The latter are anisotropic media, in which the index of refraction depends not only on the wavelength λ of the radiation propagated therein and the temperature T of the crystal, but also on the direction of propagation and the polarisation ê of the radiation: n=n(λ, ê, T_).

In particular, two polarisation modes are defined which are orthogonal to each other: ordinary polarisation (êₒ) and extraordinary polarisation (êₑ).

In a uniaxial birefringent crystal, in the case of extraordinary polarisation, there is a dependency of the index of refraction on the angle θ between the wave vector \vec{k} and the axis of the crystal: nₑ=n (Δ,θ), while in the case of ordinary polarisation, the index of refraction is independent of the direction of propagation.

In view of the dependency, in a birefringent medium, of the index of refraction on frequency, temperature and angle, two main strategies for obtaining phase matching are identified:
control of the angle of incidence (“angle-tuned phase matching”). In this case, for a given temperature, the angle θ between the versor [symbol] indicating the direction of propagation of the fundamental field E_{ω} and one of the optical axes of the crystal is modified. The polarisation of the field E_{ω} will thus be a linear combination of êₒ and êₑ. In this case, \vec{k}_{2ω} and \vec{k}_{ω} are not parallel, despite satisfying the more general phase-matching condition \hat{k}*\vec{k}_{2ω}=2k_{ω} thanks to the dependency of the index of refraction on the angle θ. The fact that \vec{k}_{2ω} and \vec{k}_{ω} are not parallel introduces the so-called walk-off phenomenon, that is, a widening of the profile of the beam E_{2ω} in a transverse direction to \vec{k}_{ω}, in the plane defined by \vec{k}_{ω} and \vec{k}_{2ω}. This asymmetry is usually corrected with the use of cylindrical lenses, prisms, etc. Another consequence of walk-off is a reduction in the spatial overlap between the fundamental field and the second harmonic field, with a consequent reduction in the conversion efficiency.
control in temperature (“temperature-tuned phase-matching”). In this case the versor \hat{k}_{ω}, is made to coincide with one of the principal axes of the crystal. This approach is also defined as angular noncritical phase matching, or noncritical phase matching for short, since there not a critical dependency on the angle. The maximum second harmonic generation efficiency is achieved by varying the temperature in a controlled manner, determining the value T thereof for which, at the given frequency ω of the fundamental field, one has: n(2ω, [symbol] , T)=n(ω, êₑ, T) or n(2ω, [symbol] , T) n(ω, êₒ, T).

Compared to the control of the angle of incidence, this method has the advantage of reducing the walk-off phenomenon to a minimum. In fact, as the versor \hat{k}_{ω} coincides with one of the main axes of the crystal, the versor \hat{k}_{2ω} will also, in plane wave approximation, coincide with the same optical axis.

More realistically, instead of being a plane wave, the incident laser beam will have a Gaussian profile, being focused in the central part of the crystal by means a lens, in order to increase the radiation intensity and favour the second harmonic conversion process. In this case it is necessary to take account of further effects that influence the phase-matching conditions, tied to the different Gouy phase accumulated by the fundamental and second harmonic fields along the propagation thereof, which brings about a growing phase shift as the length of the crystal increases.

Further causes of phase shift are to be found in the accumulation of walk-off in the nonlinear medium (above all in the case of angle-critical phase matching) and thermal effects, which lead to the formation of temperature gradients in the crystal as the power of the second harmonic field increases. Such thermal effects are particularly relevant in the case of temperature phase matching, since the phase-matching condition can be satisfied only locally, leading to a reduction in the overall conversion efficiency.

Though ideally the size of the second harmonic field should be proportional to the length of the crystal (E_{2ω}∝L), in reality, in the presence of phase shifts, it is advantageous to increase the length L of the crystal only up to a maximum value imposed by the coherence length: l_{c}=π/Δk, with Δk=|2\vec{k}_{ω}−\vec{k}_{2ω}| determined by the phase-matching condition of eq. 1.

In practice, moreover, there are further technical limitations on the maximum length L of the nonlinear medium, tied to the production methods for crystal growth.

In order to remedy these problems and reach high conversion efficiencies in the SHG process, several solutions are presented:

A first solution consists in placing the crystal in an optical cavity (see, by way of example, the articles Ashkin1966 [A. Ashkin et al., “Resonant optical second harmonic generation and mixing,” in IEEE Journal of Quantum Electronics, vol. 2, no. 6, pp. 109-124, June 1966, doi: 10.1109/JQE.1966.1074007], Berger1997 [V. Berger, “Second-harmonic generation in monolithic cavities,” J. Opt. Soc. Am. B 14, 1351-1360 (1997)], McDonagh2007 [McDonagh2007—L. McDonagh et al., “Low-noise 62 W CW intracavity-doubled TEM00 Nd:YVO4 green laser pumped at 888 nm,” Opt. Lett. 32(7), 802-804 (2007)]), so as to achieve an effective increase in the intensity of the fundamental field on the crystal by exploiting the condition of resonance between the optical cavity and the fundamental field.

This approach is very much utilised since it can lead to a considerable increase in the power of second harmonic radiation that is obtainable, in compact systems, in which a single nonlinear crystal is used.

However, the use of resonant cavities can be problematic at high powers, due to the high intensity of radiation that accumulates inside the cavity, which can cause instability of a thermal nature and instability of a photorefractive nature, as well as damage to the crystal and to the other optical elements present, above all in the case of high frequency second harmonic radiation (UV). Furthermore, mechanical stresses can prejudice correct alignment, causing a reduction in the gain introduced by the cavity.

A second solution consists in using a double or, more in general, multiple passage of light through the same crystal, by reflection on mirrors as shown in FIG. 1, in a non-resonant configuration. The use of concave mirrors allows the light to be refocused inside the crystal, thus avoiding the chromatic dispersion that would instead occur when using a lens.

In order that the efficiency is maximised, at every i-th passage from the crystal it is necessary in any case to take account of the possible phase delay between the fundamental field E⁽ⁱ⁾_{ω} and the second harmonic field E⁽ⁱ⁾_{2ω}, introduced by the reflection on the mirror, the dispersion of air (or another medium present between the mirror and the crystal) and the propagation through any antireflective treatments on the apertures of the crystal.

Also in the case of a multiple non-resonant passage through a same crystal, in the event of high power working conditions it will be necessary to take account of the same problems tied to the risk of damage due to the high radiation intensity, as already stated for the configuration with a resonant cavity.

A third solution consists in using a number of crystals in cascade. Given a less compact system requiring several nonlinear crystals, this approach proves particularly advantageous when one is working at high powers, since the radiation intensity in the individual crystal is reduced. By using suitable optical elements, one can control the focusing conditions in each crystal of the sequence, based on the intensity of the second harmonic radiation already present at the inlet, so as to avoid damage to the crystals caused by the excessive radiation intensity.

Through suitable measures it is possible, moreover, to have a local control of the phase-matching conditions in each crystal, so as to optimise the overall second harmonic generation efficiency.

In particular, it is necessary to compensate for the phase shifts due mainly to thermal effects (tied to the partial absorption of SHG radiation by the crystal; see, by way of example, Sabaeian2010 [M. Sabaeian, et al., “Investigation of thermally-induced phase mismatching in continuous-wave second harmonic generation: A theoretical model,” Opt. Express 18, 18732-18743 (2010)]), the dispersion of air, the presence of antireflective treatments on the optical apertures of each crystal and any other non-achromatic optical elements along the optical path.

As regards the correction of the phase mismatch, various approaches have been used to date to re-establish optimal phase-matching conditions in the case of double or multiple propagation through a same crystal or propagation through a sequence of crystals for second harmonic generation.

Among these, it is important to mention the approach of Imeshev et al. [Imeshev1998—G. Imeshev, et al., “Phase correction in double-pass quasi-phase-matched second-harmonic generation with a wedged crystal,” Opt. Lett. 23, 165-167 (1998)] for compensating for the phase shift introduced by reflection on a mirror as in FIG. 1 or the dispersion of propagation in air. The solution proposed by them is based on the use of a quasi-phase-matching crystal cut with an angle, so as to be able to vary the length of the optical path in the nonlinear medium by varying the transverse displacement Δh of the crystal, as shown schematically in FIG. 2. This approach works for quasi-phase-matching crystals for which the indices of refraction of the fundamental and SHG fields do not coincide.

Other solutions are based on exploiting the different dispersion in air for the two fields to compensate for the phase shift introduced by the reflection on the mirror by acting on the distance between the latter and the crystal, as proposed by Yarborough et al. [Yarborough1970—J. M. Yarborough, et al., “Enhancement of optical second harmonic generation by utilizing the dispersion of air”, Appl. Phys. Lett. 18, 70-73 (1971)].

Another strategy to compensate for walk-off in an angle-matched crystal caused by the different propagations of the field with ordinary and extraordinary polarisation consists in dividing the crystal into multiple segments, rotated so as to give rise to a walk-off in an opposite direction for each segment, thus minimising the overall phase shift, as described by Smith et al. [Smith1998—A. V. Smith, et al., “Increased acceptance bandwidths in optical frequency conversion by use of multiple walk-off-compensating nonlinear crystals,” J. Opt. Soc. Am. B 15, 122-141 (1998)]. The crystals can also be placed in contact as described by Zondy et al. [Zondy1996—J. Zondy, et al., “Walk-off-compensated type-I and type-II SHG using twin-crystal AgGaSe2 and KTiOPO4 devices,” Proc. SPIE 2700, Nonlinear Frequency Generation and Conversion, (1996)].

In Kumar 11 [Kumar 11—S. C. Kumar, et al., “High-efficiency, multicrystal, single-pass, continuous-wave second harmonic generation,” Opt. Express 19, 11152-11169 (2011)—Kumar11] a multicrystal device is proposed, based on crystals that satisfy the quasi-phase-matching condition, in which light is focused by means of concave mirrors with a suitable focal length. In this application the thermal effects are particularly marked and acquire growing relevance as the power of second harmonic radiation increases within the sequence of crystals, whilst at the same time it is necessary to take account of the progressive reduction in the size of the fundamental field. In order to compensate for these effects, the temperature of the individual crystals and the light focusing conditions are optimised with the aim of maximising, in a global condition of compromise, the final power of second harmonic radiation. The compensation of the relative phases between the fundamental and SHG fields is achieved by acting on the positions of the crystals to take account of dispersion in the propagation in air between the various crystals.

A further method to compensate for the phase mismatch due to thermal effects in nonlinear crystals for SHG, proposed by Liu et al. [Liu2017—X. Liu et al., “Three-crystal method for thermally induced phase mismatch compensation in second-harmonic generation,” J. Opt. Soc. Am. B 34, 383-388 (2017)], involves the combination of three birefringent crystals placed in sequence. Under temperature-tuned phase-matching conditions at a given temperature T, the two crystals at the ends are used for the generation of second harmonic radiation; the crystal in the central position, by contrast, has an inverse derivative of the phase shift with respect to temperature, so as to be able to compensate, at the same temperature T, for the phase mismatch introduced by the thermal effects in the first crystal of the sequence, thereby optimising the efficiency of the SHG process in the second. It is a passive phase shift compensation obtained by a fine adjustment (at the μm level) of the length of the central birefringent crystal.

In order to address imprecisions on the length of the crystal, the latter is inclined by a small angle until optimal compensation conditions are reached.

An active correction of the phase shift is instead carried out by Cui et al. [Cui2016—Z. Cui et al., “Compensation method for temperature-induced phase mismatch during frequency conversion in high-power laser systems,” J. Opt. Soc. Am. B 33, 525-534 (2016)], in a device for the generation of high-power second harmonic radiation, based in this case as well on a sequence of birefringent crystals: the two crystals at the ends of the sequence are used for SHG, while an electrooptical crystal is placed in the middle between the two. By adjusting the voltage applied to the latter, as already proposed in Hon1976 [D. Hon, “Electrooptical compensation for self-heating in CD*A during second-harmonic generation,” in IEEE Journal of Quantum Electronics, vol. 12, no. 2, pp. 148-151, 1976], it is possible to introduce a phase shift Δφ(V) which compensates for the phase shift that has accumulated at the output of the first crystal mainly due to thermal effects. In this manner one succeeds in increasing the overall power of SHG radiation obtainable and improving both the temperature band for which SHG occurs, and stability with respect to temperature variations.

One disadvantage of this method is tied to the high voltage required (up to ~10⁴ V), which leads to technical complications in the apparatus, compared to the sole sequence of temperature-controlled birefringent crystals.

### OBJECTS OF THE PRESEENT INVENTION

It is an object of the present invention to propose a device and a process for actively compensating for any phase shift Δφ=φ_{ω}−φ_{2ω} between the fields E_{ω}, and E_{2ω} input to a nonlinear birefringent crystal used for second harmonic generation (SHG), which resolve the abovementioned technical problems.

In particular, the proposed device is based on the use of a further dispersive element, produced, by way of example, with a further temperature-adjustable birefringent crystal. Through temperature tuning, it is possible to vary the difference in the index of refraction of the dispersive medium for the fundamental and SHG fields: Δn(T)=n_{w}(T)−n_{2ω}(T). By thus doing, one can control the phase shift Δφ∝Δn accumulated by the two fields at the output of the dispersive element. By placing this dispersive element at the inlet of the nonlinear crystal to be used for SHG, it is possible to implement a compensation for the phase shift Δφ=φ_{ω}−φ_{2ω} between the fundamental field and the SHG field already present. In this manner, it is possible to optimise the SHG efficiency also in the case of a multiple passage through the same crystal or configurations based on a number of SHG crystals, in which the phase-matching conditions can be satisfied independently.

A solution for overcoming the technical limits in the length of nonlinear crystals by using several crystals in cascade (stacking) is also proposed. In order to optimise the efficiency of the SHG process, in addition to using suitable antireflective treatments on the apertures of the crystals, it is proposed to use adjustable dispersive elements to control the relative phase Δφ between two adjacent crystals, as previously described. Such dispersive elements can be produced, by way of example, by means of birefringent crystals also made of the same material and cut with the same orientation as the nonlinear crystals mentioned above for frequency doubling. The temperature control of the phase actuator elements placed between the frequency doubling nonlinear crystals enables an accurate control of Δφ.

In addition, the adjustable dispersive elements can be produced with surfaces having a radius of curvature such as to focus the light inside the nonlinear crystals used for SHG.

A variant of this solution envisages the use of nonlinear crystals cut in such a way that they themselves perform the focusing function. This can be obtained, for example, by imposing a suitable radius of curvature on one or more optical apertures of the crystal.

The solutions proposed above can be combined with one another in order to maximise the efficiency and robustness of the SHG process.

### BRIEF DESCRIPTION OF THE DRAWINGS

FIGS. 1 and 2 represent, in respective schematic views, a device for the generation of second harmonic radiation according to the prior art.

FIGS. 3a and 3b represent, in respective schematic views, two variants of a device for the generation of second harmonic radiation according to a first embodiment of the present invention.

FIG. 4 represents, in a schematic view, a device for the generation of second harmonic radiation according to an alternative embodiment.

FIGS. 5, 6 represent, in respective schematic views, two variants of a device for the generation of second harmonic radiation according to a second embodiment of the present invention.

FIGS. 7, 8a and 8b represent, in respective schematic views, variants of a device for the generation of second harmonic radiation according to a third embodiment of the present invention.

FIG. 9 shows, in a schematic view, a further variant embodiment of the device for the generation of second harmonic radiation in FIG. 4.

FIG. 10 shows, in a schematic view, a further variant embodiment of the device for the generation of second harmonic radiation in FIG. 5.

FIG. 11 shows, in a schematic view, a further variant embodiment of the device for the generation of second harmonic radiation in FIG. 6.

FIG. 12 shows, in a schematic view, a further variant embodiment of the device for the generation of second harmonic radiation in FIG. 8a.

FIGS. 13a, 13b, 13c represent further embodiments according to the present invention produced through a combination of the previously represented embodiments.

### DESCRIPTION OF ONE OR MORE PREFERRED EMBODIMENTS ACCORDING TO THE PRESENT INVENTION

With reference to the aforesaid figures, the reference number 1 denotes in its entirety an apparatus for the generation of a second harmonic radiation from a fundamental radiation, according to the present invention.

The apparatus comprises one or more nonlinear crystals C that satisfy the condition of second harmonic generation SHG through noncritical phase matching, wherein the electromagnetic fields of the fundamental and of the second harmonic of the radiation are made to pass jointly more than once through one or more nonlinear optical crystals.

In particular, the fundamental radiation is made to pass several times through said nonlinear crystal C if a single nonlinear crystal has been provided. Or the fundamental radiation is made to pass at least once through said nonlinear crystals if several nonlinear crystals have been provided. In the latter case, the nonlinear crystals are arranged in series with each other relative to the direction of propagation of the fundamental radiation.

It should be noted that the fundamental radiation is made to pass through one or more nonlinear crystals C (in this case they are arranged in series) for the generation of the second harmonic radiation at a frequency double the frequency of the fundamental radiation.

Therefore, the second harmonic radiation is generated as a consequence of the passage of the fundamental radiation through one or more nonlinear crystals C.

The apparatus further comprises an optical phase actuator A, positioned upstream or downstream of said nonlinear crystal C with respect to the optical axis of the nonlinear crystal (in any case along the direction of propagation of the fundamental radiation), and configured to control the relative phase Δφ=φ_{ω}−φ_{2ω} present between a fundamental electromagnetic field E_{ω} with an angular frequency ω of the fundamental radiation and a second harmonic electromagnetic field E_{2ω} with an angular frequency 2_{ω} derived from the fundamental radiation, as a result of the passage of the latter through said one or more nonlinear crystals C, and also passing through said optical phase actuator A.

In other words, the phase actuator A is configured to act on the phase mismatch between the fundamental radiation and the second harmonic radiation.

It should be noted that the fundamental and the second harmonic radiations are both made to pass through the same actuator A.

In other words, the apparatus enables the relative phase between the fundamental radiation and the second harmonic to be controlled when they travel along the same optical path.

In particular, the subject matter of the present invention relates to a process for the generation of a second harmonic radiation from a fundamental radiation, said process being characterised in that it comprises a step of controlling the parameters of said optical actuator A.

This control takes place through the management of the temperature of the optical actuator A itself, or by applying electric or magnetic fields to said optical actuator A. The parameters of the optical actuator A which are varied comprise the effective geometric extent and/or the index of refraction thereof relative to the angular frequencies ω and 2ω, and/or said relative phase Δφ. The actuator can be produced, by way of example, by means of birefringent crystals also made of the same material and cut with the same orientation as the nonlinear crystals used for frequency doubling. The further process comprises a step of varying one or more of said parameters of the optical actuator A over time by controlling the temperature of the optical actuator A itself, or by applying electric or magnetic fields to said optical actuator A.

Furthermore, the process comprises performing a plurality of measurements of the power tied to the second harmonic radiation, varying one or more of said parameters of the optical actuator A over time, following the nonlinear power conversion from the angular frequency ω to the angular frequency 2ω when said fundamental electromagnetic field E_{ω} and said second harmonic electromagnetic field E_{2ω} are made to pass through said nonlinear optical crystal C and through said optical actuator A.

A determination is then made of the values, among said parameters of the optical actuator A, for which said measured power is maximum with respect to the power measured during said plurality of performed measurements.

Preferably, the step of varying one or more of said parameters of the optical actuator A over time is carried out by controlling the temperature of the optical actuator A itself. This temperature is adjusted so as to introduce a variation in the index of refraction according to the relation Δn=n_ω(T)−n_2ω(T) in order to compensate for the relative phase Δφ and thereby optimise the process of second harmonic generation in the crystal dedicated for that purpose, wherein Δn indicates the difference in the index of refraction, n_ω(T) indicates the index of refraction associated with the fundamental at a temperature T, whilst n_2ω(T) indicates the index of refraction associated with the second harmonic at a temperature T.

There exists a direct relation between the difference in the index of refraction or, equivalently, the optical path, and the relative phase shift. It follows that controlling the parameters of the actuator entails controlling the relative phase Δφ, for example with the aim of optimising the nonlinear conversion of power from the angular frequency ω to the angular frequency 2ω in the configuration in which the fundamental radiation and second harmonic fields pass jointly more than once through a nonlinear optical crystal. This allows for maximising the optical power obtainable in the process of second harmonic generation without the use of resonant optical elements.

Preferably, the process comprises providing a concave mirror S positioned downstream of the optical actuator A and of the nonlinear optical crystal C according to said main direction of propagation of the radiation, so that said output radiation is reflected back by the concave mirror S and so that it passes once again through said optical actuator A and said nonlinear optical crystal C.

It is noted that the direction of propagation can coincide with said main optical axis O also hereinafter in the present description.

FIG. 3a (first variant of a first alternative embodiment) shows a diagram of a device in which there is a nonlinear crystal C, adapted to generate second harmonic electromagnetic radiation (SHG) from an initial incident field [symbol] E \hat{ }((0)) [symbol] _ω. At the output of the crystal C, in addition to the field [symbol] E \hat{ }((1)) [symbol] _ω with an angular frequency ω, a field [symbol] E \hat{ }((1)) [symbol] _2ω with an angular frequency 2ω is present. The temperature T_C of the crystal is controlled so as to work under temperature phase matching (noncritical phase matching) conditions, so that n_ω(T_c)=n_2ω(T_c).

FIG. 3a shows a first embodiment in which the mirror has its own optical axis which is aligned with respect to the main optical axis O of the nonlinear optical crystal C so that said output radiation is reflected back by the concave mirror S according to a direction which is aligned with respect to the main optical axis O.

The curvature and distance of the mirror are chosen in such a way as to obtain focus conditions that maximise the SHG conversion efficiency, in order to maximise the power associated with the final SHG field [symbol] E \hat{ }((2)) [symbol] _2ω.

For the purpose of compensating for the phase shift Δφ=φ_ω−φ_2ω, which can accumulate between [symbol] E \hat{ }((1)) [symbol] _ω and [symbol] E \hat{ }((1)) [symbol] _ω because of various factors (including the propagation through air, the reflection on the mirror, thermal effects in the crystal, the Gouy phase, etc.), an actuator A is introduced, which makes it possible to control Δφ by acting on an external parameter. The actuator can consist, by way of example, of a birefringent crystal such as LBO (lithium triborate). The temperature of the actuator A, T_A, need not necessarily satisfy the phase-matching conditions for A. It must rather be such as to introduce a variation in the index of refraction Δn=n_ω (T)−n_2ω (T) to compensate for Δφ and thus optimise the SHG process in the crystal dedicated for that purpose. To avoid the accumulation of relative phases on the two wavefronts (i.e., a dependency of the relative phase along the transverse direction with respect to the wave vectors), it is advisable that Δn<<1. For this reason, it is preferable that the actuator be made of the same material and have the same cut as the nonlinear crystal which satisfies the noncritical phase-matching condition.

FIG. 3b shows a second variant of FIG. 3a in which the light reflected back by the mirror is slightly out of alignment. The operating principle is not modified.

In this variant embodiment, the concave mirror S has its own optical axis which is angled by a predefined angle with respect to the main optical axis O so that said output radiation is reflected back by the concave mirror according to a direction which is not aligned with respect to the main optical axis O of the nonlinear optical crystal so that it passes through a portion of said nonlinear optical crystal C which is different from that of a first passage of said fundamental radiation through the same nonlinear optical crystal.

According to further embodiments, the process comprises providing a plurality of nonlinear crystals Cᵢ and Cᵢ₊₁, which are all aligned according to the main optical axis O thereof, and interposing at least one optical actuator between two of them. The relative phase between the fundamental electromagnetic field and the second harmonic field at the inlet of every nonlinear crystal is controlled by means of said optical actuator A.

According to a possible embodiment of the present invention, there is an optical actuator A interposed between every pair of nonlinear crystals Cᵢ and Cᵢ₊₁ for every i-th crystal.

FIG. 5 (first variant of a second alternative embodiment) represents an actuator A consisting of a temperature-controlled birefringent medium (T_A) which makes it possible to compensate for any phase shift, due for example to an antireflective coating, between the fields [symbol] E \hat{ }((1)) [symbol] _ω and [symbol] E \hat{ }((1)) [symbol] _2ω before the entry into the next crystal.

In accordance with a second variant of the second embodiment in FIG. 5, the process comprises interposing between said nonlinear crystals Cᵢ and Cᵢ₊₁ a focusing element F for focusing the radiation in the nonlinear crystal located after said focusing element according to the main optical axis O.

In particular said focusing element (F) is produced with a lens made of birefringent material so that the index of refraction is the same for the electromagnetic fields E_{ω} and E_{2ω}: n_{ω}=n_{2ω}; the process comprises adjusting the temperature of the lens Tₗₑₙₛ so as to enable not only focusing of the radiation in the SHG crystal, but also control over the phase shift Δφ=φ_{ω}−φ_{2ω} in order to implement the function of said phase actuator A.

In detail, in FIG. 6 the actuator A has one or both of the input and output surfaces optically configured so as to focus the fields like a lens. The temperature of the lens T_lens of this device is controlled for the purpose of controlling both the phase shift Δφ=φ_{ω}−φ_{2ω} and the focus, thereby allowing the laser beam to be refocused in each of the subsequent crystals. In order to limit chromatic aberrations, this device for controlling the relative phase Δφ, and at the same time for focusing the fields, is preferably produced with a material for which the indices of refraction for the fundamental and SHG fields are identical, except for the fine tuning of phase delay necessary to control the phase shift. The material with which the nonlinear crystal is produced can satisfy the requirement if cut with the optical axes oriented along the appropriate direction.

In accordance with a third embodiment of the present invention illustrated in FIGS. 8a and 8b, it is shown how at least one of said nonlinear crystals Cᵢ and Cᵢ₊₁ has at least one optical aperture cut with a radius of curvature such as to focus the optical fields. Preferably, at least one of said nonlinear crystals Cᵢ and Cᵢ₊₁ has both optical apertures cut with a radius of curvature such as to focus the optical fields. Advantageously, thanks to the phase-matching property of the material of the crystal, no problems of chromatic dispersion exist.

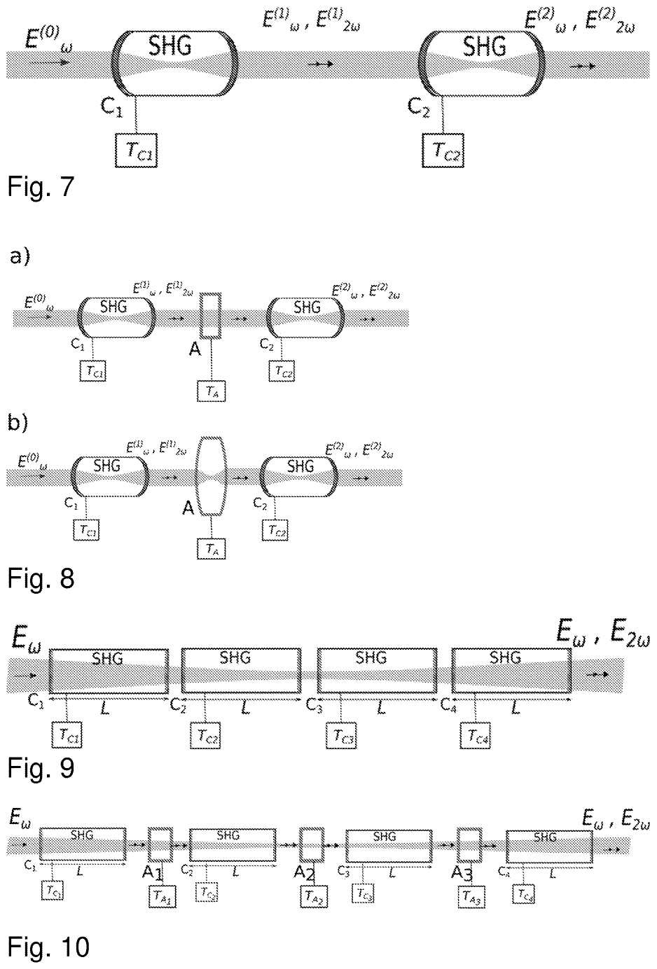

This further embodiment is shown generically in FIG. 7, in which, for the purpose of maximising the frequency doubling efficiency in each crystal, one or both faces of the nonlinear crystals are cut with a radius of curvature such as to acquire the function of the lens in FIG. 6, thereby limiting the divergence of the beams, and thus favouring the focusing of light on the same crystal, for example C_1, or on successive nonlinear crystals C_2, C_3 . . . C_n.

In particular, in FIG. 8a an actuator A is added, consisting of a temperature-tuned birefringent dispersive medium with the aim of controlling the phase shift Δφ=φ( [symbol] E \hat{ }((1)) [symbol] _ω−φ( [symbol] E \hat{ }((1)) [symbol] _2ω input to the next crystal. In FIG. 8b, the actuator also has optical apertures cut with a radius of curvature such as to focus the light inside it.

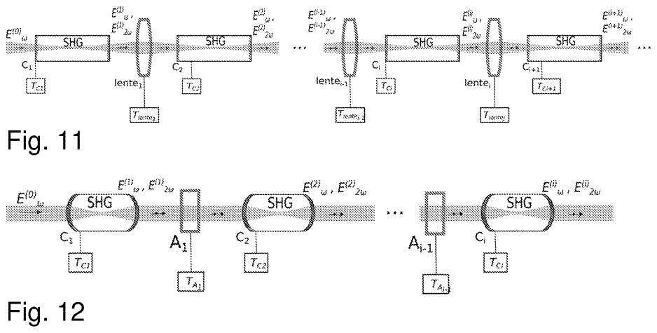

FIGS. 9-13 show further variants produced through combinations of the previous solutions, extended to a number of crystals.

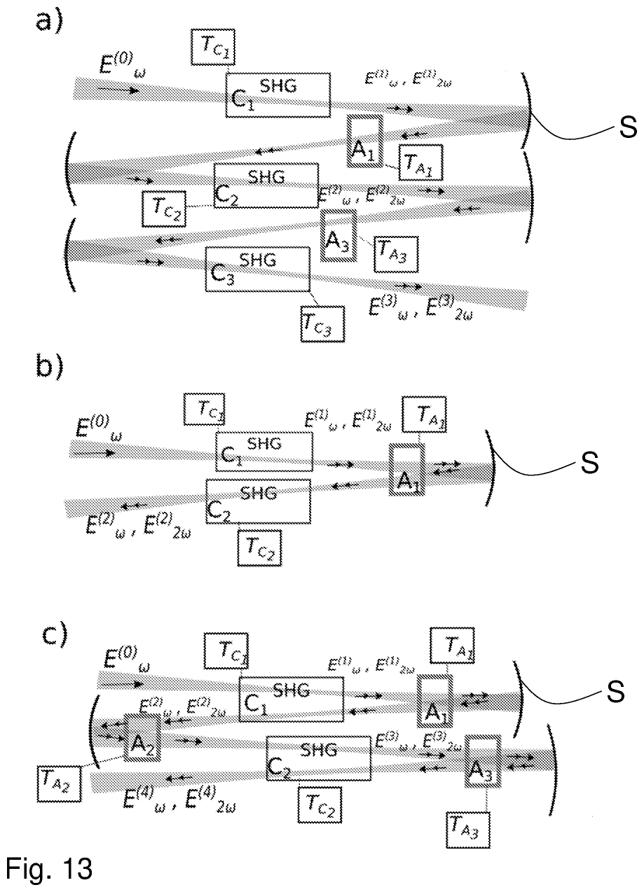

In particular, FIGS. 13a, 13b, 13c show the embodiment represented in FIG. 10, in which the length of the apparatus has been reduced thanks to the use of concave mirrors interposed between a nonlinear crystal and the subsequent actuator or vice versa.

In general, it should be noted that the nonlinear crystals for second harmonic generation (SHG) shown in FIGS. 5-10 are all meant to be used under temperature-tuned noncritical phase-matching conditions and for this purpose an independent temperature control T_c is present for every crystal.

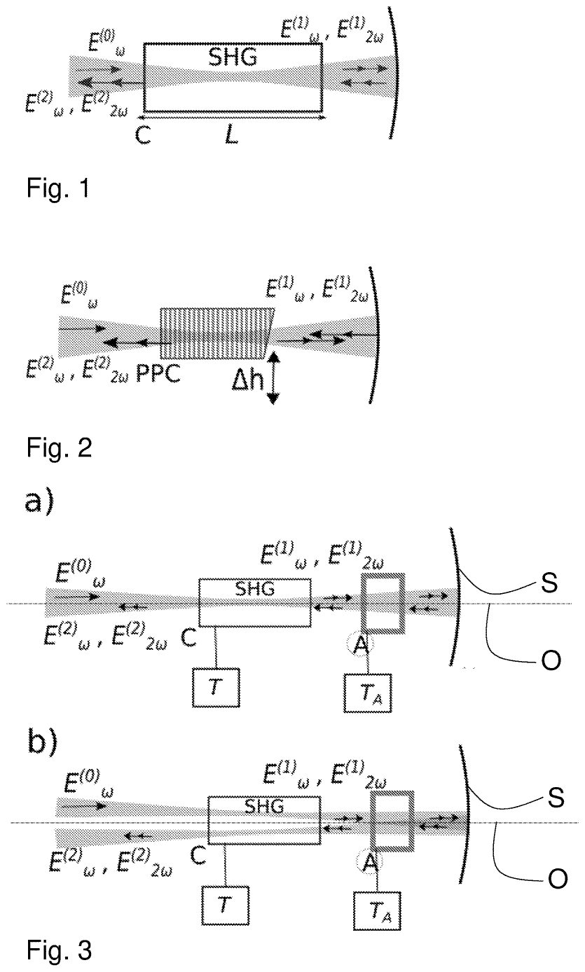

The appended figures also include FIG. 1, which shows a basic scheme in which an electromagnetic field is made to propagate twice through a nonlinear crystal by means of back reflection on a concave mirror, according to the prior art.

FIG. 2 illustrates the use, according to the prior art, in a configuration like in FIG. 1, of a periodically poled crystal (PPC) under quasi-phase-matching conditions. In this configuration, the exit face of the nonlinear crystal is not parallel to the entry one. By translating the crystal along the direction perpendicular to the optical axis it is thus possible to vary the length of the optical path. This makes it possible to correct any phase shift between the electromagnetic fields E_ωed E_2ω at the second passage through the crystal.

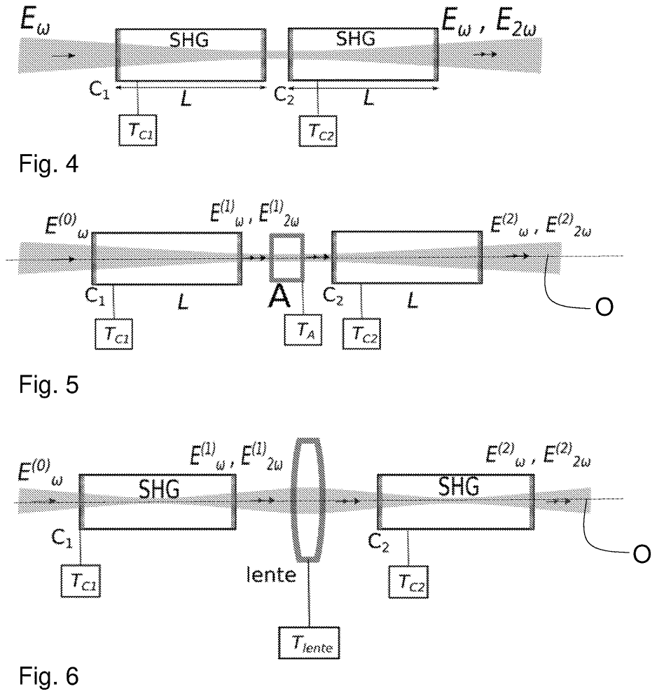

FIG. 4 shows a diagram of a device in which a number of nonlinear crystals (C1, C2) are arranged in sequence, for the purpose of obtaining a greater SHG conversion efficiency. This configuration makes it possible to get around the technical limits typical of the production of large-sized crystals. The optical apertures of each crystal can be provided with an antireflective coating.

The temperature of each crystal is controlled independently, the temperature T_(C i) of each (in this case, i=1,2) being varied so as to optimise the phase matching.

The incident electromagnetic field is focused in the central part of the device, in a Rayleigh range z_R which, for example, satisfies the relation of optimisation of the conversion z_R≃L/3, where L is the overall length of the series of crystals.

The subject matter of the present invention also relates to an apparatus 1 that implements the above-described process, which is thus entirely referenced herein also for the apparatus 1.

1-13. (canceled)

14. A process for the generation of a second harmonic radiation from a fundamental radiation having its own predefined frequency, comprising the following operating steps:
providing one or more nonlinear crystals, arranged in series along a direction of propagation of the fundamental radiation, that satisfy the condition of second harmonic generation through noncritical phase matching;
passing a same fundamental radiation through said one or more nonlinear crystals, so that, following the passage of the fundamental radiation through said one or more nonlinear crystals, a second harmonic radiation is generated which has a frequency double the predefined frequency of the fundamental radiation, wherein the electromagnetic fields of the fundamental and of the second harmonic of the radiation are likewise made to pass jointly through said one or more nonlinear optical crystals;
said fundamental radiation being made to pass several times through said nonlinear crystal if a single nonlinear crystal has been provided so that said nonlinear crystal is passed through several times by an optical path travelled by the fundamental radiation and by the second harmonic radiation, or said fundamental radiation being made to pass at least once through said nonlinear crystals if several nonlinear crystals have been provided so that the optical path travelled by the fundamental radiation and by the second harmonic radiation extends inside each nonlinear crystal; and
providing an optical phase actuator, positioned along the direction of propagation of the fundamental radiation, and passing through it both said fundamental radiation and said second harmonic radiation; said optical actuator being configured to control the relative phase Δφ=φ_{ω}−φ_{2ω} present between a fundamental electromagnetic field (E_{ω}) with an angular frequency (ω) of the fundamental radiation and a second harmonic electromagnetic field (E_{2ω}) with an angular frequency (2ω) derived from the fundamental radiation as a result of the passage of the latter through said one or more nonlinear crystals, and also passing through said optical phase actuator;
characterised in that it comprises a step of controlling the parameters of said optical actuator by controlling the temperature of the optical actuator itself, or by applying electric or magnetic fields to said optical actuator, wherein said parameters of the optical actuator comprise the effective geometric extent and/or the index of refraction thereof relative to the angular frequencies (ω) and (2ω), and/or parameters that influence said relative phase (Δφ);
said process further comprising:
a step of varying one or more of said parameters of the optical actuator over time by controlling the temperature of the optical actuator itself, or by applying electric or magnetic fields to said optical actuator;
performing a plurality of measurements of the power tied to the second harmonic radiation, varying one or more of said parameters of the optical actuator over time, following the nonlinear power conversion from the angular frequency (ω) to the angular frequency (2ω) when said fundamental electromagnetic field (E_{ω}) and said second harmonic electromagnetic field (E₂ω) are made to pass jointly through said nonlinear optical crystal and through said optical actuator; and
determining said parameters of the optical actuator for which said measured power is maximum with respect to the power measured during said plurality of measurements performed.

15. The process according to claim 14, characterized in that said step of varying one or more of said parameters of the optical actuator over time is carried out by controlling the temperature of the optical actuator itself; said temperature being adjusted so as to introduce a variation in the index of refraction according to the relation Δn=n_ω(T)−n_2ω(T) in order to compensate for the relative phase (Δφ) and thereby optimise the process of second harmonic generation in the crystal dedicated for that purpose, wherein Δn indicates the difference in the index of refraction, n_ω(T) indicates the index of refraction associated with the fundamental at a temperature (T) of the crystal, whilst n_2ω(T) indicates the index of refraction associated with the second harmonic at a temperature (T) of the crystal.

16. The process according to claim 14, characterized in that, if a single non-linear crystal has been provided, a concave mirror (S) is provided, which is positioned downstream of the optical actuator and of the nonlinear optical crystal according to a direction of propagation of the fundamental radiation, so that said output radiation is reflected back by the concave mirror (S) and passes once again through said optical actuator and said nonlinear optical crystal.

17. The process according to claim 16, wherein said mirror has its own optical axis which is aligned with respect to a main optical axis (O) of the nonlinear optical crystal, so that said output radiation is reflected back by the concave mirror (S) according to a direction which is aligned with respect to the main optical axis (O).

18. The process according to claim 16, wherein said concave mirror (S) has its own optical axis which is angled by a predefined angle with respect to a main optical axis (O) of the nonlinear optical crystal, so that said output radiation is reflected back by the concave mirror according to a direction which is not aligned with respect to the main optical axis (O) of the nonlinear optical crystal and passes through a portion of said nonlinear optical crystal which is different from that of a first passage of said fundamental radiation through the same nonlinear optical crystal.

19. The process according to claim 14, characterized in that a plurality of nonlinear crystals (Cᵢ) and (Cᵢ₊₁) is provided, which are all aligned according to the main direction of propagation of the radiation, and at least one optical actuator is interposed between at least two of them; said process envisages that the relative phase between the fundamental electromagnetic field and the second harmonic field at the inlet of every nonlinear crystal is controlled by means of said optical actuator.

20. The process according to claim 19, characterized in that it comprises a step of interposing between said nonlinear crystals (Cᵢ) and (Cᵢ₊₁) a focusing element (F) for focusing the radiation in the nonlinear crystal located after said focusing element according to the main direction of propagation of the radiation.

21. The process according to claim 20, wherein said focusing element (F) is produced with a lens made of birefringent material so that the index of refraction is the same for the electromagnetic fields (E_{ω}) and (E_{2ω}): n_{ω}=n₂ₐ; the process comprises adjusting the temperature of the lens (Tₗₑₙₛ) so as to enable not only focusing of the radiation in the SHG crystal, but also control over the phase shift Δφ=φ_{ω}−φ_{2ω} in order to implement the function of said phase actuator.

22. The process according to claim 14, wherein at least one of said nonlinear crystals (Cᵢ) and (C_{i+‘}) has at least one optical aperture cut with a radius of curvature such as to focus the optical fields entering the crystal or collimate the optical fields exiting the crystal.

23. The process according to claim 22, wherein at least one of said nonlinear crystals (Cᵢ) and (C_{i+‘}) has both optical apertures cut with a radius of curvature such as to focus and/or collimate the optical fields.

24. The process according to claim 14, characterized in that it is implemented without the use of a resonance chamber or optical resonators or without the use of a resonant optical cavity.

25. The process according to claim 14, characterized in that the actuator is configured to control the relative phase between the fundamental radiation and the second harmonic when they travel along the same optical path.

26. An apparatus for the generation of a second harmonic radiation from a fundamental radiation, comprising:
one or more nonlinear crystals, arranged in series along a direction of propagation of the fundamental radiation, that satisfy the condition of second harmonic generation through noncritical phase matching, wherein the electromagnetic fields of the fundamental and of the second harmonic of the radiation are made to pass several times through said nonlinear crystal if a single nonlinear crystal has been provided, or said fundamental radiation being made to pass at least once through said nonlinear crystals if several nonlinear crystals have been provided;
an optical phase actuator, positioned along the direction of propagation of the fundamental radiation, and passing through it both said fundamental radiation and said second harmonic radiation; said optical actuator being configured to control the relative phase Δφ=φ_{ω}−φ_{2ω} present between a fundamental electromagnetic field (E_{ω}) with an angular frequency (ω) of the fundamental radiation and a second harmonic electromagnetic field (E_{2ω}) with an angular frequency (2_{ω}) derived from the fundamental radiation as a result of the passage of the latter through said one or more nonlinear crystals, and also passing through said optical phase actuator,
characterised in that said optical phase actuator is configured to vary its parameters according to what is defined in one or more of the preceding claims.
